(19) United States
(12) Patent Application Publication
(10) Pub. No.: US 2021/0002950 A1
(43) Pub. Date: Jan. 7, 2021

(54) Heat-insulating Window Frame Being Capable of Preventing Rainwater from Backflowing

(71) Applicant: Hangzhou Pacific Ocean Plastic Building Materials Co., Ltd., Hangzhou (CN)

(72) Inventor: Xiaohai Zheng, Hangzhou (CN)

(21) Appl. No.: 16/537,573

(22) Filed: Aug. 10, 2019

(30) Foreign Application Priority Data
Jul. 3, 2019 (CN) 201910595954.4

(51) Int. Cl. E06B 7/14; E06B 3/263

(52) U.S. Cl. CPC E06B 7/14; E06B 3/2632

(57) ABSTRACT

The present application relates to a window frame capable of preventing rainwater from backflowing. One embodiment comprises a window frame consisted of four first profile. The first profile comprises a first mounting part and a second mounting part. Four first mounting parts encloses a mounting zone, which is divided into a first sub-zone and a second sub-zone by a central post. A second profile is mounted only in the second sub-zone, being on top of the lowest first profile. The second profile can prevent rainwater from flowing back into the room and provide good safety.

### CROSS REFERENCE TO RELATED APPLICATIONS

This application claims the priority of Chinese patent application No. 201910595954.4 filed on Jul. 3, 2019, all the contents of which are incorporated herein by reference and form a part of this disclosure.

### TECHNICAL FIELD

The present application relates to the field of safe heat insulating window frame, and in particular, to a heat insulating window frame capable of preventing rainwater from backflowing.

### BACKGROUND

As a necessary facility for residential housing building, a window plays the role of ventilation, sound insulation and dust-proof. At present, a window mainly includes a sliding window, a casement window, and inverted window, among which the sliding window and the casement window are more common in real life.

In particular, the existing sliding windows are usually composed of a window frame, a window sash and movable parts. As shown in FIG. 1 and FIG. 2, the window frame serves the function of positioning and supporting the window sash. The rectangular window frame is constructed by four identical profiles joined end to end. Further, a central post 7 is fixed in the window frames. The profile 6 includes a first mounting part 61 and a second mounting part 62, which are arranged along the width direction of the profile 6, that is, the horizontal direction from indoor to outdoor. When the four profiles 6 are combined into a complete window frame, the four first mounting parts 61 are joined end to end to enclose a regular first mounting zone 63, and, also, the four second mounting parts 62 enclose a second mounting zone 64, which is farther from the outdoor than the first mounting zone 63. The central post 7 is fixed within the first mounting zone 63, and divides the first mounting zone 63 into a first sub-zone 65, in which a fixed sash is mounted, and a second sub-zone 66, in which a movable sash can be mounted, so that sliding or rotating the movable sash can achieve the opening/closing of the second sub-zone 66.

In particular, in order to mounting the fixed sash more steadily, the part of the first mounting part 61 adjacent to outdoor is usually fixed with a blocking part 8, the presence of which makes it difficult for the rainwater falling into the second unit zone 66 to be drained outdoors, especially in the case of a heat-insulating window frame (which, for guaranteeing heat insulation, is usually not provided with a drain hole in communication with the outdoor), so that the rainwater will be eventually accumulated in the second unit zone 66. Once the user slides or rotates the moveable sashes to open the second unit zone 66, the accumulated rainwater might be flow back into the room, degrading the indoor environment.

### BRIEF SUMMARY

An object of the present invention is to provide a heat-insulating window frame capable of preventing rainwater from backflowing, which can reduce the possibility of rainwater flowing back into a room.

The above object of the present invention can be achieved by the technical solutions as follow:

a heat insulating window frame capable of preventing rainwater from backflowing, comprising: a window frame formed by four first profiles joined end to end and a central post fixed within the window frame, the first profile comprising a first mounting part and a second mounting part arranged along the width direction of the first profile, the four first mounting part enclosing a first mounting zone, the central post being fixed within the first mounting zone and dividing the first mounting zone into a first sub-zone for mounting a fixed sash and a second sub-zone, the four second mounting parts enclosing a second mounting zone for mounting a movable sash, a blocking strip which is adjacent to outdoor being fixed on the side of the first mounting part facing the first mounting zone, a second profile being mounted within the second sub-zone, on top of and in parallel with the lowest first profile, and having a upper end higher than the upper end of the blocking strip; and the upper end of the side of the second profile adjacent to the second mounting zone being higher than that of the side thereof far from the second mounting zone.

By adopting the above technical solution, the above combination of the first profile and the second profile can drive the rainwater falling into the second sub-zone to flow toward outdoor, thereby preventing the rainwater from being accumulated in the second mounting zone, and further preventing the rainwater from flowing back into the room. The second profile can be mounted while or after forming the first profile by joining.

Further, the side of the first mount part facing the first mounting zone is provided with a mounting slot of glass clamping strip which is in parallel with the length direction of the first profile; and a sliding snap connector is fixed on the lower side of the second profile and snap connected in the mounting slot of glass clamping strip.

By adopting the above technical solution, a way for connecting the second profile and the first profile is disclosed, by which, when performing mounting, the sliding snap connector can be slid into the mounting slot of glass clamping strip from one end thereof, four first profiles can be joined to form a complete frame, and the second profiles can be stably positioned on the first profiles; or, alternatively, after joining the four first profiles, the second profile can be added to the first profiles, and the sliding snap connector can be directly pressed into the mounting slot of glass clamping strip due to the characteristics that a synthetic resin has some resettable elasticity.

In particular, during processing the existing first profile, in order to fixing the fixed sash by using a glass clamping strip, it is necessary to set a mounting slot of glass clamping strip. Therefore, the second profile according to the above technical solution is adapted to the existing conventional first profile, without the need of customizing a special first profile, thereby having a more applicable range, especially being able to be added within the frame that has been put in use, as described in the background.

Further, the side of the first mounting part facing the first mounting zone is provided with a subsidiary mounting slot, which is in parallel with the length direction of the mounting slot of glass clamping strip; and a sliding snap connector is fixed on the lower side of the second profile, and is snap connected in the subsidiary mounting slot.

By adopting the above technical solution, the second profile can be connected with the first profile more stably by limiting the sliding snap connector by the mounting slot of glass clamping strip and limiting the subsidiarity snap connector by the subsidiary mounting slot, since the subsidiary sliding snap connector has the same function as that of the sliding snap connector.

Further, the mounting slot of glass clamping strip is recessed into the side of the first mounting part adjacent to the first mounting zone; and a sliding snap connector is fixed on the lower side of the second profile, and interference inserted into the mounting slot of the glass clamping strip.

By adopting the above technical solution, another way of connecting the second profile to the first profile is disclosed, that is, the second profile can be interference inserted into the mounting slot of glass clamping strip via a sliding snap connector, so as to achieve the connection of the second profile with the first profile.

Further, the second profile is provided with a bonding layer, which is on the lower side of the second profile and/or the side of the second profile adjacent to the blocking strip.

By adopting the above technical solution, another way of connecting the second profile to the first profile is disclosed, that is, the second profile can be connected to the first profile via bonding.

Further, a positioning bolt is mounted on the second profile for fixing the second profile onto the upper side of the first profile.

By adopting the above technical solution, another way of connecting the second profile to the first profile is disclosed, that is, the second profile can be connected to the first profile via bolt connection.

Further, a connecting assembly is provided between the second profile and the first profile, which comprises a slide-in slot and a sliding connector fit in the slide-in slot which are connected to the first profile and the second profile, respectively, or connected to the second profile and the first profile, respectively.

By adopting the above technical solution, another way of connecting the second profile to the first profile is disclosed, that is, the second profile can be connected to the first profile via an intermediate connecting assembly.

Further, a flow deflector is fixed on the second profile and positioned above the blocking strip.

By adopting the above technical solution, the flow deflector can prevent rainwater from leaking into the gap between the second profile and the blocking strip, eventually reducing the amount of rainwater leaked to the second mounting part via the gap between the second profile and the first mounting part, that is, reducing the negative influence of the rainwater on the window frame.

Further, the side of the second profile adjacent to the second mounting zone is provided with a second strip slot.

By adopting the above technical solution, a strip can be mounted on the second strip slot. Therefore, when the second profile is mounted onto the upper side of the first mounting part, the width of the strip in the second strip slot is also extended into the connection gap between the movable sash and the second mounting part, serving the function of air tightening and heat insulating, and at the same time, the function of reducing the possibility of rainwater flowing into the second mounting part.

Further, the side of the second mounting part facing the second mounting zone is provided with a mounting groove for mounting a fixed sash, the bottom of which is spaced from the side of the first mounting part adjacent to the first mounting zone.

By adopting the above technical solution, since the movable sash has to be moved back and forth in the second mounting zone, the connection place of the movable sash with the second mounting part is usually the place where the heat is mostly dissipated in the whole window. However, after the movable sash is mounted into the mounting slot, the connection of the movable sash with the second mounting part is approximately U-shaped, which, in comparison with the approximately straight-line connection gap present in the existing window frame, has significantly better heat insulating performance due to the U-shaped configuration.

In summary, the embodiments of the present application have the beneficial effects as follow:

1. in some embodiments, by using the above ways of combining the first profile and the second profile, the rainwater falling into the second sub-zone can be flowed out of the room, thereby preventing rainwater from being accumulated in the second mounting zone, and thus preventing the rainwater from flowing back into the room. In addition, the second profiled can be mounted while or after forming the first profiles by joining;

2. in some embodiments, a plurality of ways for connecting the second profile to the first profile are disclosed, that is, the second profile can be connected to the first profile via the ways of snap connection, inserting connection, bonding connection, bolt connection, etc.;

3. in some embodiments, the flow deflector can prevent rainwater from leaking into the gap between the second profile and the blocking strip, eventually reducing the amount of rainwater leaked to the second mounting part via the gap between the second profile and the first mounting part, that is, reducing the negative influence of the rainwater on the window frame.

4. in some embodiments, the bottom of the mounting slot as provided is spaced from the side of the first mounting part adjacent to the first mounting zone, so that the connection gap of the movable sash with the second mounting part is approximately U-shaped, which, in comparison with the approximately straight-line connection gap present in the existing window frame, has significantly better heat insulating performance due to the U-shaped configuration;

5. in some embodiments, the window frame has good safety performance, eliminating the possibility of the sash falling to the outdoor and causing safety accident.

### BRIEF DESCRIPTION OF DRAWINGS

FIG. 1 is a schematic structural view of the window frame described in the Background according to the present application.

FIG. 2 is a schematic cross-sectional view of the profile described in the Background according to the present application.

FIG. 3 is a schematic structural view of a window frame according to Embodiment 1 according to the present application.

FIG. 4 is a schematic cross-sectional view taken along line B-B of FIG. 3.

FIG. 5 is a schematic cross-sectional view taken along line A-A of FIG. 3.

FIG. 6 is an enlarged schematic view of the portion C in FIG. 4.

FIG. 7 is a schematic sectional view of the central post according to Embodiment 1 according to the present application.

FIG. 8 is a schematic cross-sectional structural view of Embodiment 2 according to the present application.

FIG. 9 is a schematic cross-sectional structural view of Embodiment 3 according to the present application.

FIG. 10 is a schematic cross-sectional structural view of Embodiment 4 according to the present application.

FIG. 11 is a schematic cross-sectional structural view of Embodiment 5 according to the present application.

FIG. 12 is a partial schematic structural view of Embodiment 6 according to the present application.

FIG. 13 is a schematic structural view of Embodiment 7 according to the present application.

FIG. 14 is a schematic diagram of the detection environment used in Embodiment 8.

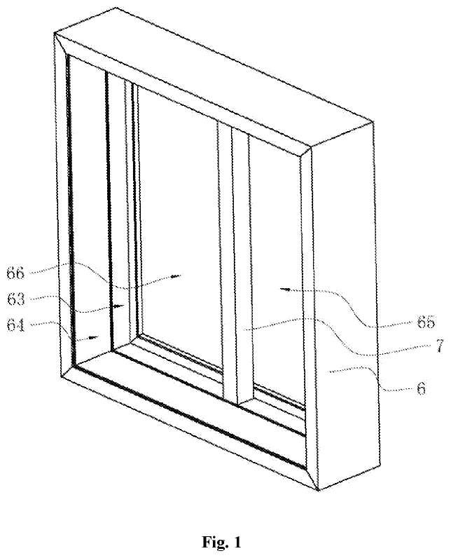

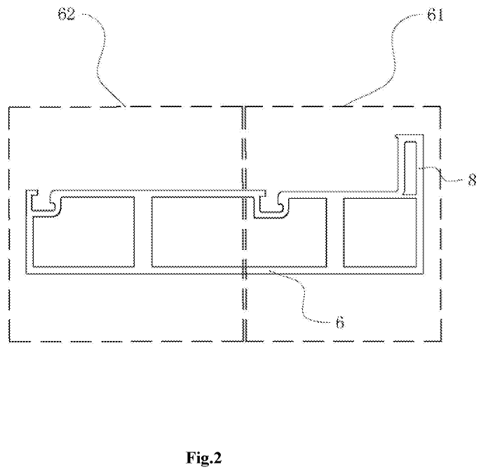

The reference numbers in the drawings of the present application refer to: 1.the first profile; 11.the first mounting part; 111.the first strip slot; 112.mounting slot of glass clamping strip; 113.snap slot; 114.subsidiary mounting slot; 115.subsidiary snap slot; 12.the second mounting part; 13.the first mounting zone; 14.the second mounting zone; 15.the first sub-zone; 16.the second sub-zone; 17.the first strip-like heat insulating chamber; 18.mounting groove; 19.the first dividing plate; 2.the central post; 21.limiting part; 3.the second profile; 31.water retaining strip; 32.blocking strip; 33.flow deflector; 34.the second strip-like heat insulating chamber; 35.the second strip slot; 36.bonding layer; 37.positioning bolt; 38.mounting strip; 39.the second dividing plate; 4.sliding snap connector; 41.guiding barb; 42.subsidiary sliding snap connector; 43.subsidiary guiding barb; 5.connecting assembly; 51.sliding slot; 52.sliding connector; 53.test sample opening; 54.electric radiator; 55.evaporator; 56.wind deflector; 57.blower; 58.low-temperature chamber; 59.high temperature chamber

The reference numbers in the drawings related to the Background refer to: 6. profile; 61. first mounting part; 62. second mounting part; 63. first mounting zone; 64. second mounting zone; 65. first sub-zone; 66. second sub-zone; 7. central post; 8. blocking part.

### DETAILED DESCRIPTION

Detailed description of the embodiments according to the present application will be further made in combination with the drawings.

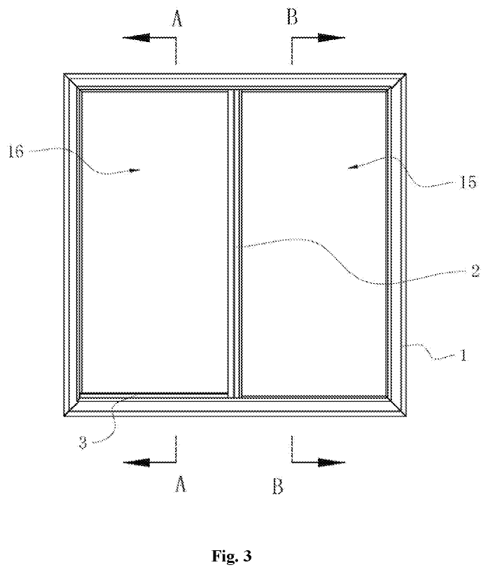

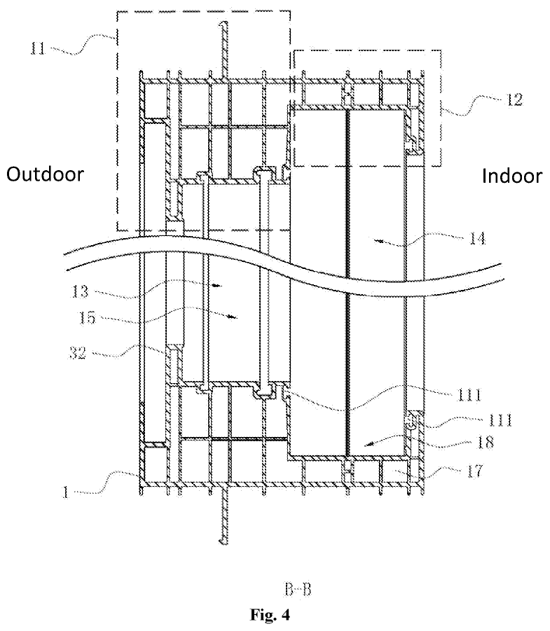

Embodiment 1: referring to FIGS. 3 and 4, a heat insulating window frame capable of preventing rainwater from backflowing is shown, which comprises: a window frame formed by four first profiles joined end to end, and a central post fixed within the window frame. The first profile 1 comprises a first mounting part 11 and a second mounting part 12 arranged along the width direction of the first profile 1, that is, the horizontal direction from indoor to outdoor. The four first mounting parts 11 on the four first profile 1 enclose a first mounting zone 13. The central post 2 is vertically fixed within the first mounting zone 13, and divides the first mounting zone 13 into a first sub-zone 15 for mounting a fixed sash and a second sub-zone 16. The four second mounting parts 12 enclose a second mounting zone 14 for mounting a movable sash, which can be pushed or pulled by a user along the horizontal direction to open or close the second sub-zone 16.

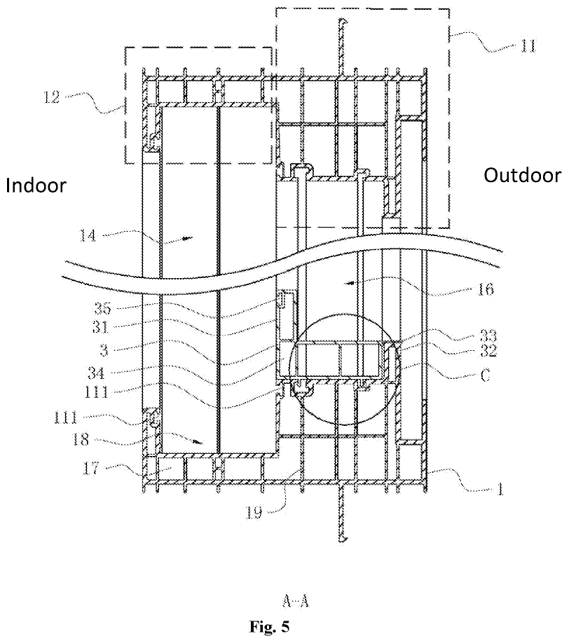

Referring to FIG. 5, one side of the second mounting part 12 facing the second mounting zone 14 is provided with a mounting groove 18 for mounting the movable sash, the bottom of which is below the side of the first mounting part 11 facing the first mounting zone 13. Since the movable sash has to be moved back and forth within the second mounting zone 14, the joint of the movable sash and the second mounting part 12 is usually the place where the heat is mostly dissipated. However, after the movable sash is mounted into the mounting groove 18, an approximately U-shaped connection gap is formed between the movable sash and the second mounting part 12, which, in comparison with the approximately straight-line connection gap present in the existing window frame, has a significantly better heat insulating performance due to the U-shaped configuration. A first strip slot 111 is recessed into each of the two side walls of the mounting groove 18, and is in parallel with the length direction of the first profile. After the movable sash is mounted into the mounting slot 18, the width of the strip mounted in the first strip slot 111 is extended into the connection gap, serving the function of air tightening and heat insulating. The first profile 1 is hollow, and provided with several first dividing plates 19 which divide the first profile 1 into several strip-like first heat insulating chambers 17. The several strip-like first heat insulating chambers 17 are not communicated with each other, and have a length direction in parallel with the length direction of the first profile 1. Two rows, at least three per row, of the first strip-like heat insulating chamber 17 are provided within the first mounting part 11 and arranged along the thickness direction of the firs profile 1, and one row, at least four per row, of the first strip-like heat insulating chamber 17 is provided within the second mounting part 12.It is to be noted that, since the several first strip-like heat insulating chambers 17 are not communicated with each other and are in parallel with the first profile 1, the heat will be stopped layer to layer when being delivered from indoor to outdoor within the second mounting part 12 and the first mounting part 11, thereby providing excellent heat insulating property.

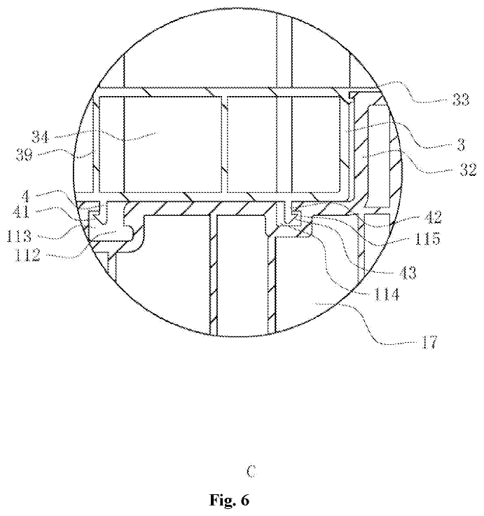

Referring to FIGS. 5 and 6, the side of the first mounting part 11 facing the first mounting zone 13 is provided with a blocking strip 32, which is integrally formed and in parallel with the first profile 11, and located far from the second mounting part 12. The blocking strip 32 is used for reducing the possibility of the fixed sash falling off the window frame, and providing some support for the stable mounting of the fixed sash.

A second profile 3 is mounted only in the second sub-zone 16, on top of and in parallel with the lowest profile 1, and the upper side of the second profile 3 is higher than the upper end of the blocking strip 32. The second profile 3 primarily serves the function of preventing rainwater from backflowing into the second mounting zone 14 from the second sub-zone 16. A water retaining strip 31 is protruded from the upper side of the second profile 3, and located at the side of the second profile 3 adjacent to the second mounting part 12. Due to the blocking of the water retaining strip 31, it is difficult for the rainwater falling onto the upper side of the second profile 3 to flow back into the second mounting part 12, eventually reducing the possibility of the rainwater flowing back into the room, and, at the same time, preventing the rainwater falling into the second mounting zone 14 from negatively influencing the movement of the movable sash. A flow deflector 33 is fixed on the second profile 3 and abuts on the blocking strip 32, below the upper end of the water retaining strip 31. The flow deflector 33 can prevent the rainwater from leaking into the gap between the second profile 3 and the blocking strip 32, eventually reducing the amount of rainwater leaking to the second mounting part 12 through the gap between the second profile 3 and the first mounting part 11, and, in turn, reducing the negative influence of the rainwater on the window frame.

The inside of the second profile 3, the water retaining strip 31, and the inside of the blocking strip are hollow, and a plurality of second dividing plates 39 are fixed within the second profile 3 and the water retaining strip 31. A plurality of the second dividing plates 39 are used to divide the inside of the second profile 3 or the water retaining strip 31 into several second strip-like heat insulating chambers 34, which, at least four in number, are not communicated with each other, and have a length direction in parallel with that of the second profile 3. A second strip slot 35 in parallel with the second profile 3 is recessed into the side of the second profile 3 adjacent to the second mounting part 12, in which a strip can be mounted. When the second profile 3 is mounted on the upper side of the first mounting part 11, the U-shaped connection gap can be extended to reduce heat dissipation. Further, when the strip is mounted in the second strip slot 35, part of its width is extended into the connection gap, serving the function of air tightening and heat insulating. Also, the strip can reduce the possibility of the rainwater falling into the second mounting part 12.

It is to be noted that, due to the second strip-like heat insulating chamber 34 provided in the second profile 3, the mounting of the second profile 3 on the upper side of the first mounting part 11 correspondingly increases the number of layers for stopping the delivery of heat in the first profile 1 along the thickness direction of the first profile 1, thereby helping reduce the loss of heat in the room. Further, the mounting of the second profile 3 can extend the length of the connection gap, thereby reducing heat delivery efficiency. In addition, since the first mounting part 11 is located on the side of the connection gap adjacent to outdoor, the delivery of heat in the connection gap from indoor to outdoor can be further stopped.

More preferably, there are at least four of the first strip-like heat insulating chambers 17 per row provided in the first mounting part 11, and there are at least four of the second strip-like heat insulating chambers 34 provided in the second profile 3, in which three of the second strip-like heat insulating chambers 34 are arrange in one row, and another second strip-like heat insulating chamber 34 is located above the row of the three second strip-like heat insulating chambers 34, that is, within the water retaining strip 31. Such a configuration constitutes a special combination of heat insulating chambers, so that the heat delivered from the second mounting part 12 to the first mounting part 11, whether being delivered along the horizontal direction or along the thickness direction of the first profile 1 (the upward direction in FIG. 5), has to pass through at least four first strip-like heat insulating chambers 17 or the second strip-like heat insulating chambers 34, which reduces the heat delivery efficiency and guarantees the heat isolating and insulating performances of the window frame.

Referring to FIGS. 5 and 6, the second profile 3 and the first mounting part 11 is particularly connected as follows: a mounting slot 112 of glass clamping strip and a subsidiary mounting slot 114 are recessed into the first mounting part 11, both of which are in parallel with the length direction of the first profile 1; and, when the fixed sash is fixed within the first mounting zone 13, a glass clamping strip (not shown) can be snap connected in the mounting slot 112 of glass clamping strip, and clamp and position the fixed sash in coordination with the blocking strip 32.

The lower side of the second profile is fixed with a sliding snap connector 4, and a guiding barb 41 is provided at the lower end of the sliding snap connector 4. The wall of the mounting slot 112 of glass clamping strip is recessed with a snap slot 113, in which the guiding barb 41 can be partly snap connected. In particular, when performing mounting, the sliding snap connector 4 can be slid into the mounting slot 112 of glass clamping strip from one end thereof, and four first profiles 1 can be joined together to form a complete frame body. Alternatively, the mounting can be performed as follows: under the guiding of the guiding barb 41, the sliding snap connector 4 can be resettably deformed to some extent, and inserted into the mounting slot 112 of glass clamping strip, after which, the sliding snap connector 4 is reset and snap connected in the snap connector 13 to connect the second profile 3 to the first profile 1.

It is to be noted that, the sliding snap connector 4 can assume a long strip-like shape, be in parallel with the mounting slot 112 of glass clamping strip, and have a length equal to that of the second profile 3. Alternatively, the sliding snap connector 4 can assume a non-strip-like shape, and, instead, several sliding snap connectors 4 can be arranged in equal intervals along the length direction of the mounting slot 112 of glass clamping strip.

A subsidiary sliding snap connector 42 is fixed on the lower side of the second profile 3, and a subsidiary guiding barb 43 is provided at the lower end of the subsidiary sliding snap connector 42. A subsidiary snap slot 115 is recessed into the wall of the subsidiary mounting slot 114, in which the subsidiary guiding barb 43 can be partly snap connected. In particular, when performing mounting, the subsidiary snap connector 42 can be slid into the subsidiary mounting slot 114 from one end thereof, and then four first profiles 1 can be joined together to form a complete frame body. Alternatively, the mounting can be performed as follows: under the guiding of the subsidiary guiding barb 43, the subsidiary sliding snap connector 42 can be resettably deformed to some extent, and inserted into the subsidiary mounting slot 114, after which, the subsidiary sliding snap connector 42 is reset and snap connected in the subsidiary snap slot 115 to achieve a firmer connection of the second profile 3 with the first profile 1.

It is to be noted that, the subsidiary snap connector 42 can assume a long strip-like shape, be in parallel with the subsidiary mounting slot 114, and have a length equal to that of the second profile 3. Alternatively, the subsidiary snap connector 42 can assume a non-strip-like shape, and, instead, several subsidiary snap connectors 42 can be arranged in equal intervals along the length direction of the subsidiary mounting slot 114. The subsidiary snap connector 42 has the same function as that of the sliding snap connector 4, and thus, limiting the sliding snap connector 4 by the mounting slot 112 of glass clamping strip and limiting the subsidiary snap connector 42 by the subsidiary mounting slot 114 connect the second profile 3 to the first profile 1 more stably.

In particular, the first profile 1, the second profile 3, and the central post can be preferably made from a synthetic resin material.

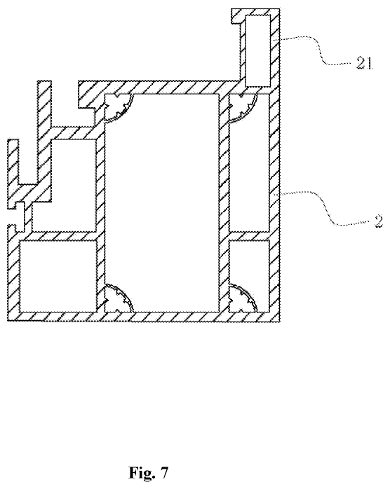

Referring to FIG. 7, the central post is integral with a limiting part 21 thereon, which can confine the mounting zone of the fixed sash in coordination with the blocking strip 32, so that the fixed sash can only be removed from inside of the room, but cannot fall out of the room. Since the area of the second sub-zone 16 is smaller than that of the movable sash, and the movable sash is connected to the side of the fixed sash adjacent to the room, the movable sash cannot fall out of the room via the second sub-zone 16, and thus, when the fixed sash and the movable sash are mounted into the window frame, the window frame has excellent safety performance, eliminating the possibility of the sash falling out of the room and causing safety accident.

The principle for carrying out the embodiments of the present application lies in that, the structure of the profiles is redesigned in the present application, that is, the first profile 1 is provided with the first mounting part 11 and the second mounting part 12, so that the connection gap of the movable sash and the second mounting part 12 assumes approximately U shape after mounting, which, in comparison with the approximately straight-line connection gap in the existing window frame, has significantly better heat insulating performance due to the U-shaped configuration.

Furthermore, the second profile 3 can guide the rainwater falling into the second sub-zone 16 to flow outward, preventing the rainwater from backflowing. Furthermore, the second strip-like heat insulating chambers 34 provided inside the profile 3 can isolate the heat delivered from the first profile 1, so as to further improve heat insulating performance.

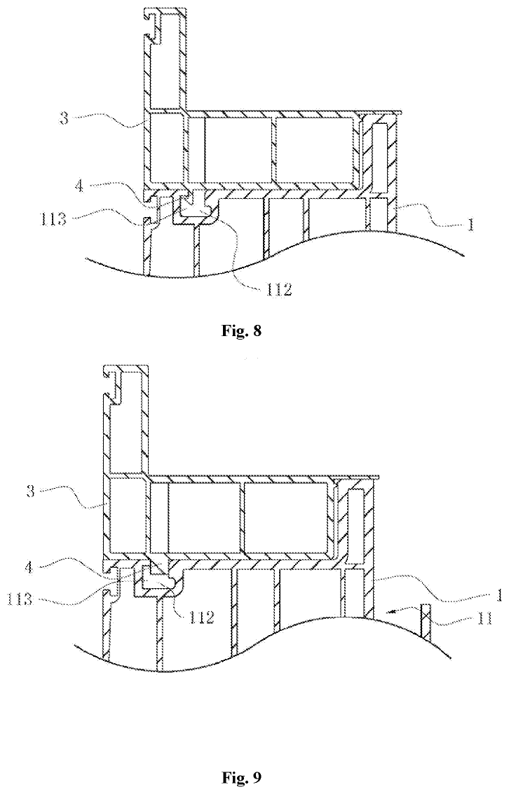

Embodiment 2: referring to FIG. 8, this embodiment differs from Embodiment 1 only in that, there is no subsidiary sliding snap connector 42, subsidiary guiding barb 43, subsidiary mounting slot 114, or subsidiary snap slot 115 provided, that is, the profile 3 is snap connected to the mounting slot 112 of glass clamping strip only via the sliding snap connector 4.

The principle for carrying out this embodiment lies in that, the difference of this embodiment from Embodiment 1 is that, the second profile 3 is directly applied to the window frame described in the Background, since the mounting slot 112 of glass clamping strip and the snap slot 113 have to be provided in order to fix the fixed sash via glass clamping strip (see FIG. 6) during the processing of the existing first profile 1. Therefore, the second profile 3 according to this embodiment is adapted to existing conventional first profile 1, without the need of customizing the first profile 1 according to Embodiment 1, so that it can be more widely used, especially can be applied to the window frame that has been put into use, as described in the Background.

Embodiment 3: referring to FIG. 9, this embodiment differs from Embodiment 2 only in the structure of the sliding snap connector 4, that is, in this embodiment, the sliding snap connector 4 is connected to the first mounting part 1 via interference insertion.

The principle for carrying out this embodiment is the same as that of the Embodiment 2.

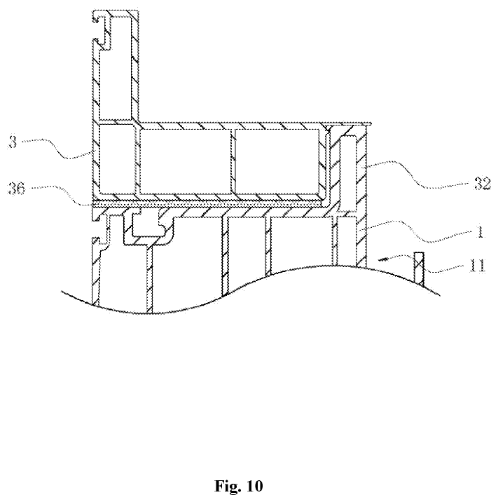

Embodiment 4: referring to FIG. 10, this embodiment differs from Embodiment 1 only in the structure for connecting the second profile 3 to the first mounting part 11. In particular, in this embodiment, a bonding layer 36 is provided on the second profile 3, which can be on the lower side of the second profile 3, or on the side of the second profile 3 adjacent to the blocking strip 32, or both. Preferably, the bonding layer 36 is only provided on the lower side of the second profile 3.

The principle for carrying out this embodiment lies in that, the connection of the second profile 3 with the first mounting part 11 can be achieved by bonding.

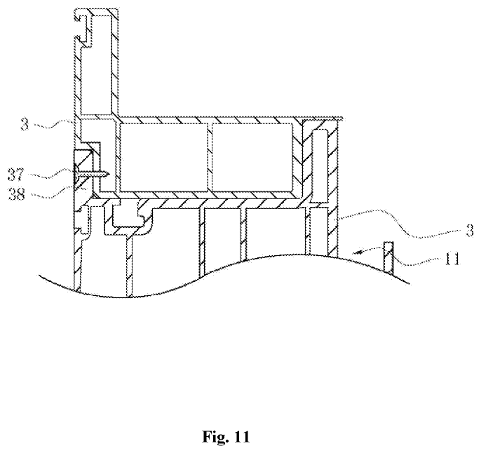

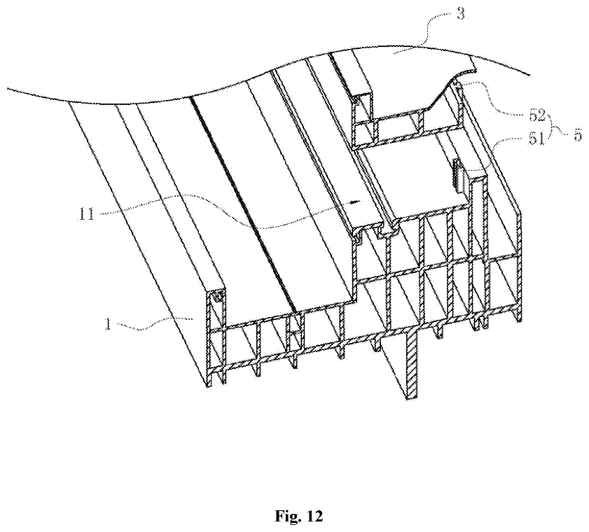

Embodiment 5: referring to FIG. 11, this embodiment differs from Embodiment 1 only in the structure for connecting the second profile 3 to the first mounting part 11. In particular, a mounting strip 38 is fixed on the upper side of the first mounting part 11, and a positioning bolt 37 is threaded through the mounting strip 38 along the horizontal direction, extending into the second profile 3.

The principle for carrying out this embodiment lies in that, the connection of the second profile 3 with the first mounting part 11 can be achieved by bolt connection.

Embodiment 6: referring to FIG. 12, this embodiment differs from Embodiment 1 only in the structure for connecting the second profile 3 to the first mounting part 11. In particular, a connecting assembly 5 is provided between the second profile 3 and the first profile 1, comprising a slide-in slot 51 and a sliding connector 52 fit in the slide-in slot, which are connected to the first profile 1 and the second profile 3, respectively, or connected to the second profile 3 and the first profile 1, respectively. The connecting assembly 5 can be on the lower side of the second profile 3, or the side of the second profile 3 adjacent to the blocking strip 32. Preferably, the connecting assembly 5 is located on the side of the second profile 3 adjacent to the blocking strip 32, and the slide-in slot 51 and the sliding connector 52 are connected to the blocking strip 32 and the second profile 3, respectively. The cross section of the sliding connector 52 is of T shape, and the sliding connector 52 is snapped in the slide-in slot 51 vertically. The user can mount the sliding connector 52 into the slide-in slot 51 from up to down, so as to achieve the connection of the second profile 3 to the first profile 1.

The principle for carrying out this embodiment lies that, the connection of the second profile 3 with the firs mounting part 11 can be achieved by a connecting assembly 5.

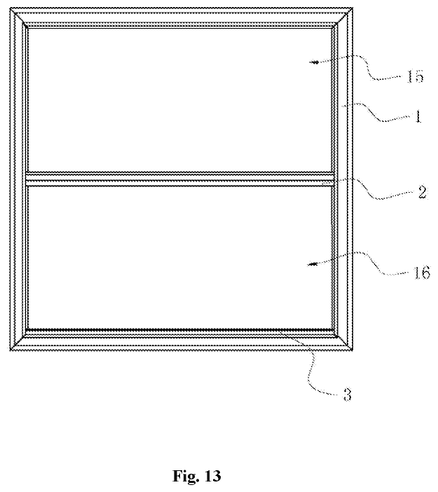

Embodiment 7: referring to FIG. 13, this embodiment differs from Embodiment 1 only in that, the central post is horizontally positioned, so that the first sub-zone 15 and the second sub-zone 16 are arranged one above another, and the movable sash can be pushed or pulled upwards or downwards.

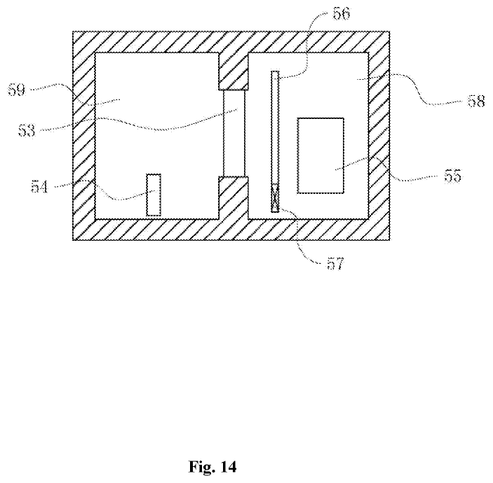

Embodiment 8: referring to FIG. 14, the test sample comprises: a whole window formed by the window frame according to Embodiment 1 and glass, wherein the window frame has a width of 138 mm, the ratio of the width of the first mounting part 11 to that of the second mounting part 12 is 1:1, the thicknesses of the first mounting part 11 and the second mounting part 12 are 54 mm and 18 mm, respectively, the heating area of the whole window is 2 m*2 m=4 m², there are five first strip-like heat insulating chambers 17 provided in the second mounting part 12 and ten first strip-like heat insulating chambers 17 provided in the first mounting part 11, the window frame is made of a synthetic UPVC resin, and the glass is an irradiation-proof glass, having a thickness of 37 mm.

The control sample is a whole window formed by the window frame as described in the Background and glass, wherein the window frame has a width of 138 mm, the ratio of the width of the first mounting part 61 to that of the second mounting part 62 is 1:1, both of the thicknesses of the first mounting part 61 and the second mounting part are 36 mm, the heating are of the whole window is 2 m*2 m=4 m²,there are three heat insulating chambers in the window frame in total, the window frame is made of the same synthetic resin as that used in the test sample in Embodiment 1, and the glass is the same kind of radiation-proof glass as that used in the test sample in Embodiment 1, having a thickness of 37 mm.

The testing method is performed as follows: referring to FIG. 13, the heat insulating performance of the window was tested via the calibrated hot-box test method based on the principle of steady-state heat transfer according to Standard GB/T8484-2002. The test site was a closed space consisted of a low-temperature chamber and a high-temperature chamber. A test sample opening was provided between the low-temperature chamber and the high-temperature chamber for mounting the test sample or control sample (abbreviated as “sample” below) therein, with the gap being sealed. The low-temperature chamber 58 was located at one side of the sample, imitating the outdoor weather condition in winter, and the high-temperature chamber 59 was located at the other side of the sample, imitating the indoor weather condition in winter in a heated building. The air temperature, air speed, and heat radiation conditions were keep stable on both sides of the sample. A heat transfer coefficient K was calculated by dividing the value obtained by deducting the heat losses on the outer wall of high-temperature chamber 59 and the sample from the amount Q of heat generated by an electric radiator provided in the high-temperature 59 by the product of the heating area S of the sample and the air temperature difference T3 between the two sides of the sample, and a smaller heat transfer coefficient K indicated a better heat insulating effect, where the heat loss on the outer wall of the high-temperature 59 was obtained by the area-weighed mean temperature difference T1 between the inner surface and the outer surface of the high-temperature chamber 59 timing the heat conductivity M1 of the outer wall of the high-temperature chamber 59 as determined in a calibration test, and the heat loss on the sample is obtained by the area-weighed mean temperature difference T2 between the two surfaces of the sample timing the heat conductivity M2 of the sample as determined in a calibration test.

The heat transfer coefficients K were calculated by detected T1, T2, T3, and S in combination with known Q, M1, and M2, which were used in the embodiment for comparing and analyzing the test sample over the control sample.

The temperature in the high-temperature chamber was set within 18° C. to 20° C. by controlling the power of the electric radiator 54 in the high-temperature chamber 59, with a temperature fluctuation of smaller than 0.1K; and the temperature in the low-temperature chamber 58 was set within −21° C. to −19° C. by controlling the power of the cooling device in the low-temperature chamber, with a temperature fluctuation of smaller than 0.3K.

During the test, two groups of testing were performed in total. In Group 1, the temperature of the high-temperature chamber 59 was set at 18° C., and the temperature of the low-temperature chamber 58 was set at −21° C.; and, in Group 2, the temperature of the high-temperature chamber 59 was set at 20° C., and the temperature of the low-temperature chamber 58 was set at −19° C. Four sets of data were detected and recorded for each group, with a time interval of 10 min between two adjacent data detections.

Test instruments: a copper-constantan thermocouple was used as the temperature sensing element, an electric radiator 54 was used as the heating device in the high-temperature chamber 59, an evaporator 55 was used as the cooling device in the low-temperature chamber 58 or cold air was introduced into the low-temperature chamber 58 to lower the temperature, and a wind deflector 56 and a blower 57 were provided in the low-temperature chamber 58 to achieve forced convection, producing uniform up-to-down air flow along the surface of the sample.

Test results: the detected heat transfer coefficients K of the test sample and the control sample are shown in table 1 below.

TABLE 1
Heat transfer coefficients K of the
test sample and the control sample

| | Group | | | | | | | |
|---|---|---|---|---|---|---|---|---|
| Sample | Group 1 | | | | Group 2 | | | |
| Test sample | 1.2 | 1.3 | 1.2 | 1.1 | 1.1 | 1.2 | 1.2 | 1.1 |
| Control sample | 2.3 | 2.3 | 2.2 | 2.3 | 2.4 | 2.3 | 2.4 | 2.5 |

It can be seen from table 1 that, the heat transfer coefficient K of the test sample is lower than that of the control sample, demonstrating that the test sample has better heat insulating performance that the control sample.

The particular embodiments in the Detailed Description are preferred embodiments of the present application, and in no way should be considered as limiting the protection scope of the present application. On the contrary, all the equivalent changes made to the structure, shape and principle of the present application should fall into the protection scope of the present application.

What is claimed is:

1. A heat insulating window frame capable of preventing rainwater from backflowing, comprising: a window frame formed by four first profiles joined end to end and a central post fixed within the window frame, the first profile comprising a first mounting part and a second mounting part arranged along the width direction of the first profile, the four first mounting part enclosing a first mounting zone, the central post being fixed within the first mounting zone and dividing the first mounting zone into a first sub-zone for mounting a fixed sash and a second sub-zone, the four second mounting parts enclosing a second mounting zone for mounting a movable sash, and a blocking strip which is adjacent to outdoor being fixed on the side of the first mounting part facing the first mounting zone; wherein a second profile is mounted within the second sub-zone, on top of and in parallel with the lowest first profile, and the upper end of the side of the second profile adjacent to the second mounting zone is higher than that of the side thereof far from the second mounting zone.

2. The heat insulating window frame capable of preventing rainwater from backflowing according to claim 1, wherein the side of the first mounting part facing the first mount zone is provided with a mounting slot of glass clamping strip which is in parallel with the length direction of the first profile; and the lower side of the second profile is provided with a sliding snap connector which is snap connected in the mounting slot of glass clamping strip.

3. The heat insulating window frame capable of preventing rainwater from backflowing according to claim 2, wherein the side of the first mounting part facing the first mounting zone is provided with a subsidiary mounting slot which is in parallel with the length direction of the mounting slot of glass clamping strip; and a subsidiary snap connector is fixed on the lower side of the second profile, and snap connected in the subsidiary mounting slot.

4. The heat insulating window frame capable of preventing rainwater from backflowing according to claim 1, wherein the mounting slot of glass clamping strip in parallel with the length direction of the first profile is recessed into the side of the first mounting part adjacent to the first mounting zone; and a sliding snap connector is fixed on the lower side of the second profile, and interference inserted into the mounting slot of the glass clamping strip.

5. The heat insulating window frame capable of preventing rainwater from backflowing according to claim 1, wherein the second profile is provided with a bonding layer, which is on the lower side of the second profile and/or the side of the second profile adjacent to the blocking strip.

6. The heat insulating window frame capable of preventing rainwater from backflowing according to claim 1, wherein the second profile is mounted with a positioning bolt for fixing the second profile on the upper side of the first mounting part.

7. The heat insulating window frame capable of preventing rainwater from backflowing according to claim 1, wherein a connecting assembly is provided between the second profile and the first profile, which comprises a slide-in slot and a sliding connector fit in the slide-in slot, which are connected to the first profile and the second profile, respectively, or connected to the second profile and the first profile, respectively.

8. The heat insulating window frame capable of preventing rainwater from backflowing according to claim 1, wherein a flow deflector is fixed on the second profile, and positioned above the blocking strip.

9. The heat insulating window frame capable of preventing rainwater from backflowing according to claim 1, wherein the side of the second profile adjacent to the second mounting zone is provided with a second strip slot.

10. The heat insulating window frame capable of preventing rainwater from backflowing according to claim 1,wherein the side of the second mounting part facing the second mounting zone is provided with a mounting groove for mounting a fixed sash, the bottom of which is spaced from the side of the first mounting part adjacent to the first mounting zone.
